(19) United States
(12) Patent Application Publication
(10) Pub. No.: US 2023/0373169 A1
(43) Pub. Date: Nov. 23, 2023

(54) METHOD FOR MOLDING HOLLOW PART OF COMPOSITE MATERIAL AND HOLLOW PART MOLDING SYSTEM

(71) Applicant: TOYOTA JIDOSHA KABUSHIKI KAISHA, Toyota-shi (JP)

(72) Inventor: Akihiro TERASAKA, Toyota-shi (JP)

(73) Assignee: TOYOTA JIDOSHA KABUSHIKI KAISHA, Toyota-shi (JP)

(21) Appl. No.: 18/183,975

(22) Filed: Mar. 15, 2023

(30) Foreign Application Priority Data
May 19, 2022 (JP) 2022-082002

(51) Int. Cl. B29C 70/44; B29C 70/46

(52) U.S. Cl. CPC B29C 70/446; B29C 70/462

(57) ABSTRACT

A method of forming a composite hollow part according to the present disclosure includes: covering a core with a first bag film; forming an intermediate body having a hollow shape by superimposing fibers of the composite material on the first bag film; placing the intermediate body together with the core and the first bag film on an outer mold; covering the outer mold with the second bag film; and demolding the molded composite hollow part by heating the intermediate body and heating the intermediate body after the atmospheric pressure of the outside of the first bag film and the inside of the second bag film is lower than the atmospheric pressure of the outside of the second bag film and the atmospheric pressure of the inside of the first bag film.

### CROSS-REFERENCE TO RELATED APPLICATION

This application claims priority to Japanese Patent Application No. 2022-082002 filed on May 19, 2022, incorporated herein by reference in its entirety.

### BACKGROUND

### 1. Technical Field

The present disclosure relates to a method for molding a hollow part of a composite material and a hollow part molding system.

### 2. Description of Related Art

Japanese Unexamined Patent Application Publication No. 9-193175 (JP 9-193175 A) discloses a method for producing a hollow resin molded part using a metal composite core.

### SUMMARY

In the method for producing the hollow resin molded part disclosed in JP 9-193175 A, irregularities are formed on the outer surface of the hollow resin molded part, so that a high-quality hollow resin molded part cannot be produced.

The present disclosure has been made in view of the above, and provides a method for molding a hollow part of a composite material and a hollow part molding system capable of molding a high-quality hollow part of a composite material.

A method for molding a hollow part of a composite material according to the present disclosure includes: covering a core with a first bag film; molding a hollow-shaped intermediate by superimposing a fiber of the composite material on the first bag film; placing the intermediate in an outer mold together with the core and the first bag film; covering the outer mold with a second bag film; heating the intermediate after bringing atmospheric pressures of an outside of the first bag film and an inside of the second bag film to atmospheric pressures lower than an atmospheric pressure of an outside of the second bag film and an atmospheric pressure of an inside of the first bag film; and demolding the hollow part of the composite material that has been molded by heating the intermediate. With this method for molding the hollow part of the composite material, a high-quality hollow part of a composite material having no unintended irregularities formed on the surface and having a uniform thickness can be molded.

The intermediate may be heated with the core attached to the intermediate.

A demolding of the hollow part of the composite material may include pulling out the core and the first bag film from the hollow part of the composite material after bringing the atmospheric pressure of the inside of the first bag film to an atmospheric pressure lower than the atmospheric pressure of the outside of the first bag film.

The outer mold may be covered with the second bag film. The core may be pulled out from the intermediate. The intermediate may be heated after the atmospheric pressures of the outside of the first bag film and the inside of the second bag film are brought to atmospheric pressures lower than the atmospheric pressure of the outside of the second bag film and the atmospheric pressure of the inside of the first bag film.

In a demolding of the hollow part of the composite material, the first bag film may be pulled out from the hollow part of the composite material after the atmospheric pressure of the inside of the first bag film is brought to an atmospheric pressure lower than the atmospheric pressure of the outside of the first bag film.

The intermediate may be heated after the atmospheric pressures of the outside of the first bag film and the inside of the second bag film are brought to a predetermined atmospheric pressure or less.

The core may be made of an elastically deformable material.

A hollow part molding system according to the present disclosure includes at least: a core; a first bag film wound around the core; an outer mold in which an intermediate molded by superimposing a fiber of a composite material on the first bag film is placed; a second bag film covering the outer mold; a pressure control device configured to be able to bring atmospheric pressures of an outside of the first bag film and an inside of the second bag film to atmospheric pressures lower than an atmospheric pressure of an outside of the second bag film and an atmospheric pressure of an inside of the first bag film; and a heating device that heats the intermediate. This hollow part molding system can mold a high-quality hollow part of a composite material having no unintended irregularities formed on the surface and having a uniform thickness.

The core may be formed of an elastically deformable material.

The present disclosure can provide a method for molding a hollow part of a composite material and a hollow part molding system capable of molding a high-quality hollow part of a composite material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing a method of molding a hollow part of a composite material according to Embodiment 1;

FIG. 2 is a schematic cross-sectional view for explaining a method for molding a hollow part of a composite material according to Embodiment 1;

FIG. 3 is a schematic cross-sectional view for explaining a method for molding a hollow part of a composite material according to Embodiment 1;

FIG. 4 is a diagram illustrating an example of a method of winding a ply;

FIG. 5 is a schematic perspective view showing a molded hollow part of a composite material and a state in which a core and a first bag film are pulled out from the molded hollow part of the composite material;

FIG. 6 is a flowchart illustrating a method of molding a hollow part of a composite material according to Embodiment 2;

FIG. 7 is a schematic cross-sectional view for explaining a method for molding a hollow part of a composite material according to Embodiment 2;

FIG. 8 is a schematic cross-sectional view for explaining a process for molding a hollow part of a composite material according to Embodiment 2; and

FIG. 9 is a schematic perspective view illustrating an example of a molded hollow part of a composite material and a state of pulling out a first bag film from the molded hollow part of the composite material.

### DETAILED DESCRIPTION OF EMBODIMENTS

Hereinafter, specific embodiments to which the disclosure is applied will be described in detail with reference to the drawings. However, the disclosure is not limited to the following embodiments. Further, the following description and drawings are simplified as appropriate for the sake of clarity.

### First Embodiment

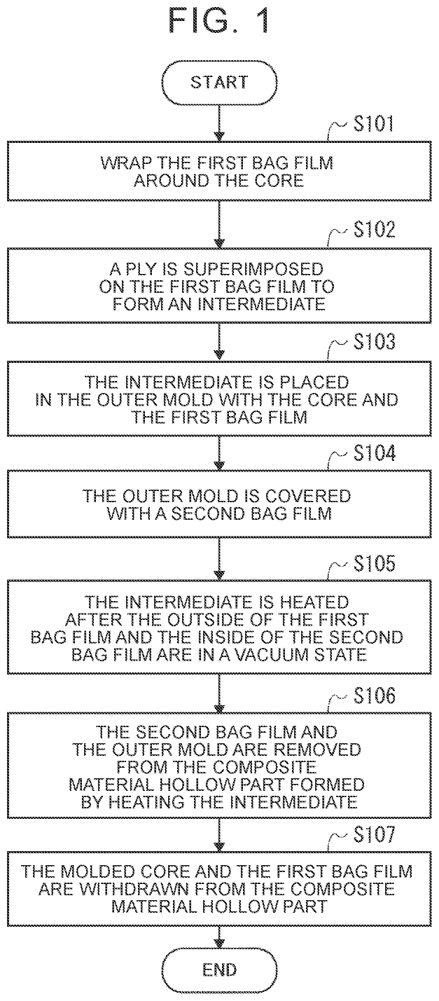

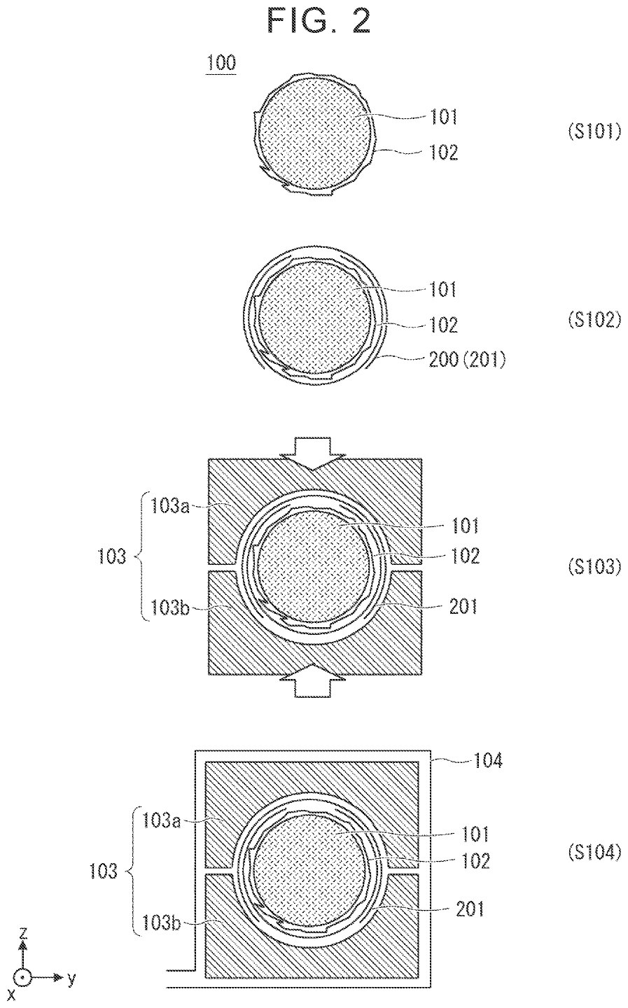

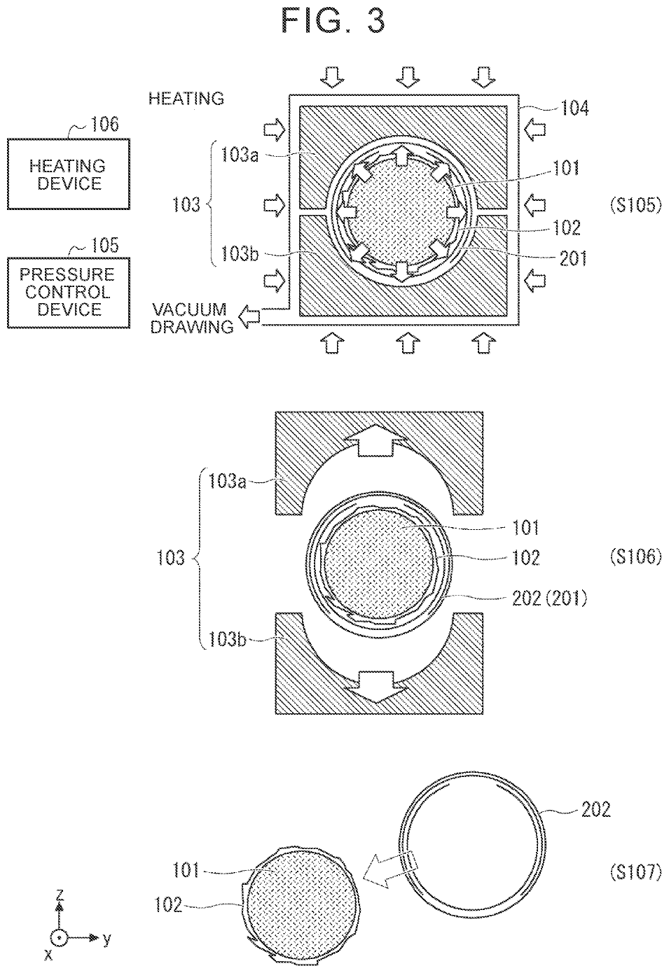

FIG. 1 is a flowchart showing a method of molding a hollow part of a composite material according to Embodiment 1. FIG. 2 and FIG. 3 are schematic cross-sectional views for explaining a method of molding a hollow part of a composite material. FIG. 2 and FIG. 3 are schematic cross-sectional views at each step of the flowchart shown in FIG. 1. In this embodiment, for example, the molding of the composite material hollow part 202 is performed by the hollow part molding system 100. Hereinafter, it will be described in detail.

The hollow part molding system 100 includes, for example, at least a core 101, a bag film (first bag film) 102, an outer mold 103, a bag film (second bag film) 104, a pressure control device 105, and a heating device 106, as shown in FIGS. 2 and 3. The composite material hollow part 202 molded by the hollow part molding system 100 is installed for reinforcement in, for example, a wind turbine blade or a propeller of an airplane.

First, the bag-film 102 is wound around the core 101 (step-wise S101).

The core 101 has a shape corresponding to the shape of the hollow portion of the composite material hollow part 202 which is a molded article. For example, the core 101 has a cylindrical shape. The core 101 is formed of a material having durability to the extent that it does not plastically deform during the molding process of the composite material hollow part 202. However, the core 101 is preferably made of an elastically deformable material such as silicon. This allows the core 101 to be easily withdrawn from the composite material hollow part 202. In addition, the core 101 may have a partially curved shape, a partially different thickness shape, or a branched shape depending on the shape of the hollow portion of the composite material hollow part 202. Even in this case, the core 101 can be pulled out from the composite material hollow part 202 without being damaged. As a result, the core 101 can be reused, and thus an increase in cost is suppressed.

The bag film 102 is airtight enough to maintain the pressure difference between the inside and the outside of the bag film 102. In addition, the bag film 102 is formed of a material having durability that is not damaged in the molding process of the composite material hollow part 202. For example, when the composite material hollow part 202 is molded with a material containing epoxy, the bag film 102 is formed of a material having heat resistance of 130 to 220 degrees or more, which is a temperature at the time of heating. When the composite material hollow part 202 is molded with a material containing polyimide, the bag film 102 is formed of a material having heat resistance of 400° C. or higher, which is a temperature at the time of heating. Further, for example, the bag film 102 is made of a material having durability such that the pressure difference between the inside and the outside of the bag film 102 is not damaged even by a pressure difference in the range of 0.3 to 10 atmospheres. More specifically, the bag film 102 is made of a material such as nylon or silicon.

Further, the bag film 102 is preferably formed of a highly stretchable material. Thereby, damage due to the sticking of the bag film 102 can be prevented. In addition, the bag film 102 is preferably wound around the core 101 in such a manner that wrinkles are intentionally entered. As a result, the bag film 102 can be prevented from being damaged due to sticking, and the degassing property can be improved.

Thereafter, the ply 200 is superimposed on the bag film 102 to mold the intermediate 201 which is the middle of molding the composite material hollow part 202 (step S102).

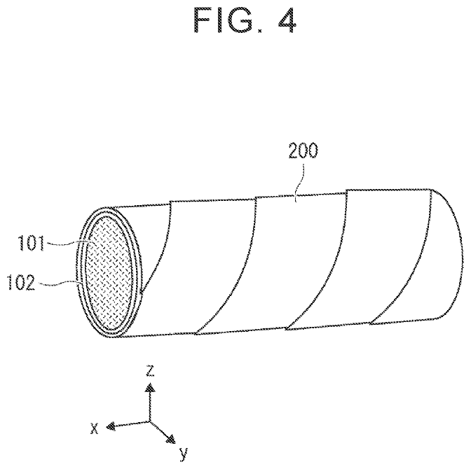

The ply 200 is a sheet-like member including fibers of a composite material. The superimposition of the plies 200 allows the molding of a high strength composite material hollow part 202. As shown in FIG. 4, by spirally winding the plies 200 on the bag film 102, it is possible to mold the composite material hollow part 202 which is resistant to torsion.

Then, the intermediate 201 is placed on the outer mold 103 together with the core 101 and the bag-film 102 (step S103). More specifically, the intermediate 201, together with the core 101 and the bag-film 102, is sandwiched between the upper mold 103a and the lower mold 103b constituting the outer mold 103. As a result, the outer surface of the intermediate 201 is formed to have a shape corresponding to the shape of the outer mold 103. In addition, it is thereby possible to prevent unintended irregularities from being formed on the outer surface of the intermediate 201.

Thereafter, the outer mold 103 is covered with the bag-film 104 (step S104). The bag film 104 is formed of the same material as the bag film 102.

Thereafter, the pressure control device 105 is used to heat the intermediate 201 by using the heating device 106, while the atmospheric pressure outside the bag film 102 and inside the bag film 104 is lower than the atmospheric pressure outside the bag film 104 and the atmospheric pressure inside the bag film 102 (step S105).

The bag film 102 and the intermediate 201 (ply 200) stick to the outer mold 103 because pressure is applied from the inside to the outside of the bag film 102 by lowering the atmospheric pressure on the outside of the bag film 102 and the inside of the bag film 104 below the atmospheric pressure on the outside of the bag film 104 and the atmospheric pressure on the inside of the bag film 102. Thereby, the inner surface of the intermediate 201 is molded into a desired shape. It is preferable that the pressure control device 105 lowers the atmospheric pressure of the outside of the bag film 102 and the inside of the bag film 104 to a predetermined atmospheric pressure or less close to the vacuum state or the vacuum state. As a result, the bag film 102 and the intermediate 201 (ply 200) can stick to the outer mold 103 under higher pressure.

Further, for example, when the intermediate 201 is formed of a material containing epoxy, the heating device 106 heats the intermediate 201 at 130 to 220 degrees. When the intermediate 201 is formed of a material containing polyimide, the heating device 106 heats the intermediate 201 at 400° C.

Thereafter, the molded composite material hollow part 202 is demolded by heating the intermediate 201 (step S106 and step S107). Specifically, first, the bag-film 104 and the outer mold 103 are removed from the composite material hollow part 202 (step S106). The core 101 and the bag-film 102 are then withdrawn from the composite material hollow part 202 (step S107). When the core 101 and the bag film 102 are pulled out from the composite material hollow part 202, the pressure inside the bag film 102 is preferably set to be lower than the outside atmospheric pressure by using the pressure control device 105 or the like. This allows the bag film 102 to be affixed to the core 101, making it easier to withdraw the core 101 and the bag film 102 from the composite material hollow part 202. The core 101 may be made of a material that shrinks when the pressure inside the bag film 102 becomes lower than the pressure outside. This makes it easier to withdraw the core 101 and the bag film 102 from the composite material hollow part 202.

As described above, in the method of forming the composite hollow part according to the present embodiment, the composite material hollow part 202 in which the fibers of the composite material are superposed is formed by performing the above-described processing using the core 101, the outer mold 103, and the bag film 102,104. Thus, in the method for molding a composite material hollow part according to the present embodiment, unevenness that is not intended to be formed on the surface is not formed. Thus, in the method for molding a composite material hollow part according to the present embodiment, it is possible to mold a composite material hollow part having a uniform thickness and high quality. That is, in the method for molding a composite material hollow part according to the present embodiment, a composite material hollow part having high strength and high quality can be molded.

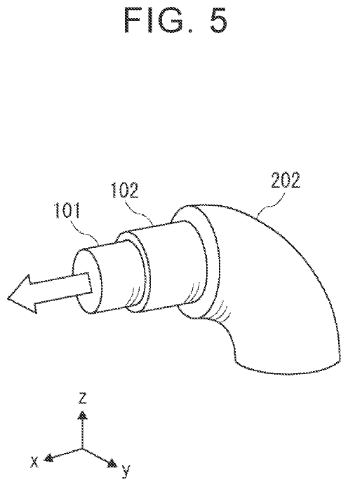

In the method for molding a composite material hollow part according to the present embodiment, the core 101 may be made of an elastically deformable material such as silicon. This allows the core 101 to be easily withdrawn from the composite material hollow part 202. Further, depending on the shape of the hollow portion of the composite material hollow part 202, the core 101 can be pulled out from the composite material hollow part 202 without damaging the core 101 even if the core has a partially curved shape, a partially different thickness shape, or a branched shape as shown in FIG. 5, for example. As a result, the core 101 can be reused, and thus an increase in cost is suppressed.

### Second Embodiment

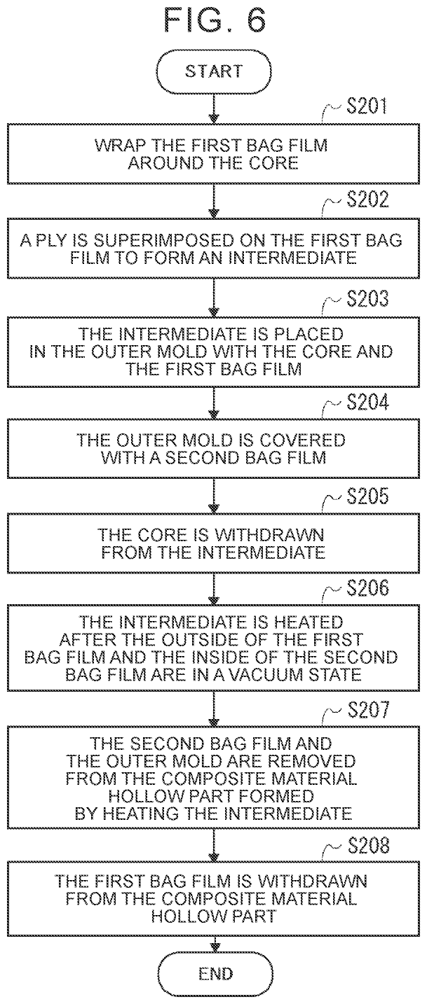

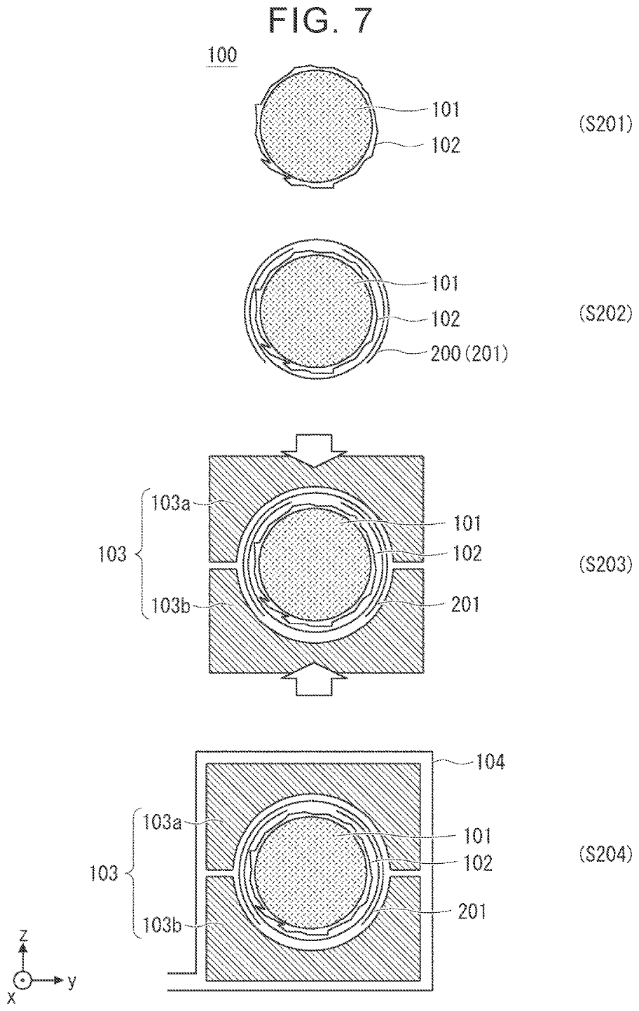

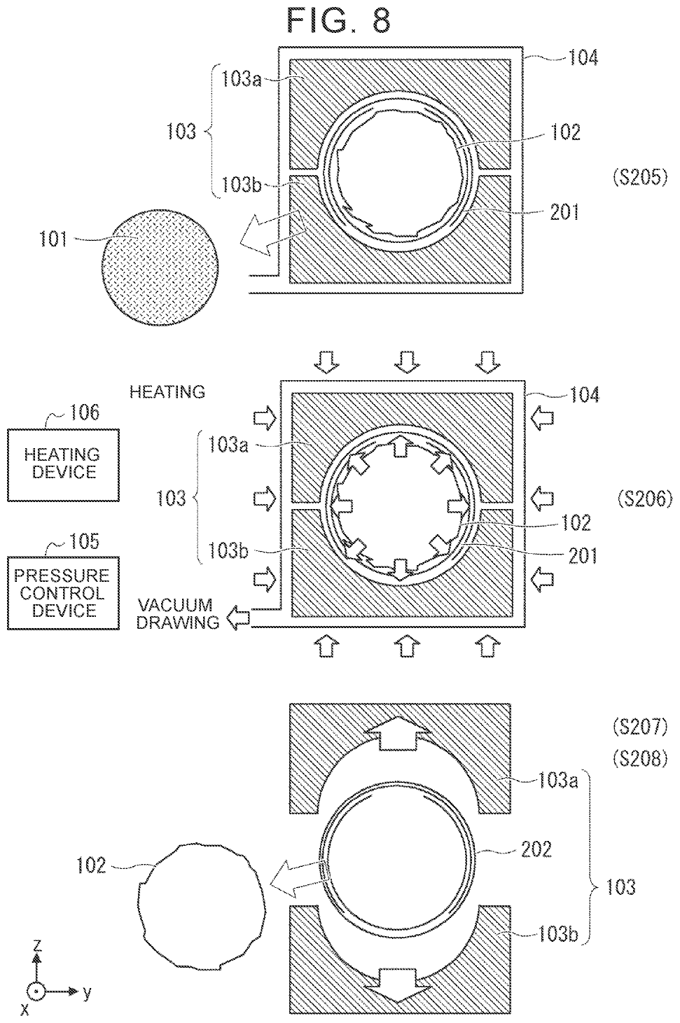

FIG. 6 is a flowchart illustrating a method of molding a composite material hollow part according to Embodiment 2. FIG. 7 and FIG. 8 are schematic cross-sectional views for explaining a method of molding a composite material hollow part. In FIG. 7 and FIG. 8, a schematic cross-sectional view of each step of the flowchart shown in FIG. 6 is shown. In this embodiment, for example, the molding of the composite material hollow part 202 is performed by the hollow part molding system 100. Hereinafter, it will be described in detail.

First, the bag-film 102 is wound around the core 101 (step-wise S201).

Thereafter, the intermediate 201 is molded by superimposing the plies 200 on the bag film 102 (step S202).

Then, the intermediate 201 is placed on the outer mold 103 together with the core 101 and the bag-film 102 (step S203). More specifically, the intermediate 201, together with the core 101 and the bag-film 102, is sandwiched between the upper mold 103a and the lower mold 103b constituting the outer mold 103. As a result, the outer surface of the intermediate 201 is formed to have a shape corresponding to the shape of the outer mold 103. In addition, it is thereby possible to prevent unintended irregularities from being formed on the outer surface of the intermediate 201.

Thereafter, the outer mold 103 is covered with the bag-film 104 (step S204).

Thereafter, the core 101 is withdrawn from the intermediate 201 prior to being heated (step S205). Thereby, the heating time of the intermediate 201 can be shortened. Note that the core 101 may be formed of a material that shrinks when the pressure inside the bag film 102 becomes lower than the pressure outside. This makes it easier to pull the core 101 out of the composite material hollow part 202 by making the pressure inside the bag film 102 lower than the outside pressure.

Thereafter, the pressure control device 105 is used to lower the atmospheric pressure on the outside of the bag film 102 and the inside of the bag film 104 than the atmospheric pressure on the outside of the bag film 104 and the atmospheric pressure on the inside of the bag film 102, and the intermediate 201 is heated using the heating device 106 (step S206).

The bag film 102 sticks to the outer mold 103 because pressure is applied from the inside to the outside of the bag film 102 by lowering the atmospheric pressure on the outside of the bag film 102 and the inside of the bag film 104 below the atmospheric pressure on the outside of the bag film 104 and the atmospheric pressure on the inside of the bag film 102. Thereby, the inner surface of the intermediate 201 is molded into a desired shape. It is preferable that the pressure control device 105 lowers the atmospheric pressure of the outside of the bag film 102 and the inside of the bag film 104 to a predetermined atmospheric pressure or less close to the vacuum state or the vacuum state. As a result, the bag film 102 can stick to the outer mold 103 under a stronger pressure.

Thereafter, the molded composite material hollow part 202 is demolded by heating the intermediate 201 (step S207 and step S208). Specifically, first, the bag-film 104 and the outer mold 103 are removed from the composite material hollow part 202 (step S207). The bag-film 102 is then withdrawn from the composite material hollow part 202 (step S208). When the bag film 102 is pulled out from the composite material hollow part 202, it is preferable to keep the air pressure inside the bag film 102 lower than the outside air pressure by using the pressure control device 105 or the like. This allows the bag film 102 to shrink, thereby facilitating withdrawal of the bag film 102 from the composite material hollow part 202.

The other processing of the method of molding the composite material hollow part according to the second embodiment is the same as that of the method of molding the composite material hollow part according to the first embodiment, and therefore the description thereof will be omitted.

As described above, in the method of forming the composite hollow part according to the present embodiment, the composite material hollow part 202 in which the fibers of the composite material are superposed is formed by performing the above-described processing using the core 101, the outer mold 103, and the bag film 102,104. Thus, in the method for molding a composite material hollow part according to the present embodiment, it is possible to mold a high-quality composite material hollow part having no unintended irregularities formed on the surface and having a uniform thickness. That is, in the method for molding a composite material hollow part according to the present embodiment, a composite material hollow part having high strength and high quality can be molded.

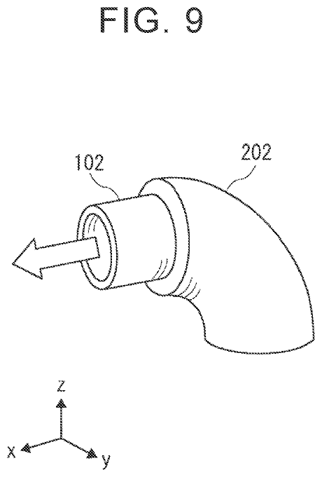

In the method for molding a composite material hollow part according to the present embodiment, the core 101 may be made of an elastically deformable material such as silicon. This allows the core 101 to be easily withdrawn from the composite material hollow part 202. Also, depending on the shape of the hollow portion of the composite material hollow part 202, the core 101 can be pulled out from the composite material hollow part 202 without damaging the core 101 even if it has a partially curved shape, a partially different thickness shape, or a branched shape, as shown in FIG. 9, for example. As a result, the core 101 can be reused, and thus an increase in cost is suppressed.

The present disclosure is not limited to the above embodiments, and can be appropriately modified without departing from the spirit thereof.

What is claimed is:

1. A method for molding a hollow part of a composite material, the method comprising:
covering a core with a first bag film;
molding a hollow-shaped intermediate by superimposing a fiber of the composite material on the first bag film;
placing the intermediate in an outer mold together with the core and the first bag film;
covering the outer mold with a second bag film;
heating the intermediate after bringing atmospheric pressures of an outside of the first bag film and an inside of the second bag film to atmospheric pressures lower than an atmospheric pressure of an outside of the second bag film and an atmospheric pressure of an inside of the first bag film; and
demolding the hollow part of the composite material that has been molded by heating the intermediate.

2. The method according to claim 1, wherein the intermediate is heated with the core attached to the intermediate.

3. The method according to claim 2, wherein a demolding of the hollow part of the composite material includes pulling out the core and the first bag film from the hollow part of the composite material after bringing the atmospheric pressure of the inside of the first bag film to an atmospheric pressure lower than the atmospheric pressure of the outside of the first bag film.

4. The method according to claim 1, wherein:
the outer mold is covered with the second bag film;
the core is pulled out from the intermediate; and
the intermediate is heated after the atmospheric pressures of the outside of the first bag film and the inside of the second bag film are brought to atmospheric pressures lower than the atmospheric pressure of the outside of the second bag film and the atmospheric pressure of the inside of the first bag film.

5. The method according to claim 4, wherein in a demolding of the hollow part of the composite material, the first bag film is pulled out from the hollow part of the composite material after the atmospheric pressure of the inside of the first bag film is brought to an atmospheric pressure lower than the atmospheric pressure of the outside of the first bag film.

6. The method according to claim 1, wherein the intermediate is heated after the atmospheric pressures of the outside of the first bag film and the inside of the second bag film are brought to a predetermined atmospheric pressure or less.

7. The method according to claim 1, wherein the core is made of an elastically deformable material.

8. A hollow part molding system comprising at least:
a core;
a first bag film wound around the core;
an outer mold in which an intermediate molded by superimposing a fiber of a composite material on the first bag film is placed;
a second bag film covering the outer mold;
a pressure control device configured to be able to bring atmospheric pressures of an outside of the first bag film and an inside of the second bag film to atmospheric pressures lower than an atmospheric pressure of an outside of the second bag film and an atmospheric pressure of an inside of the first bag film; and
a heating device that heats the intermediate.

9. The hollow part molding system according to claim 8, wherein the core is made of an elastically deformable material.
